(19) United States
(12) Patent Application Publication
(10) Pub. No.: US 2019/0227379 A1
(43) Pub. Date: Jul. 25, 2019

(54) ARRAY SUBSTRATE AND METHOD FOR MANUFACTURING THE SAME, DISPLAY PANEL AND METHOD FOR MANUFACTURING THE SAME

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Xiaojuan WU, Beijing (CN); Hongliang YUAN, Beijing (CN)

(21) Appl. No.: 16/330,315

(22) PCT Filed: Apr. 25, 2018
(86) PCT No.: PCT/CN2018/084338

§ 371 Date: Mar. 4, 2019

(30) Foreign Application Priority Data
Jul. 13, 2017 (CN) 201710569209.3

(51) Int. Cl. G02F 1/1335; G02F 1/1343

(52) U.S. Cl. CPC G02F 1/133553; G02F 1/134336; G02F 1/133514

(57) ABSTRACT

Embodiments of the present disclosure relate to an array substrate and a method for manufacturing the same, a display panel and a method for manufacturing the same. The array substrate includes a substrate, a dielectric layer located on the substrate, the dielectric layer including a matrix material layer and particles embedded into the matrix material layer and the particles forming protrusions on a surface of the dielectric layer opposite to the substrate, and a conductive layer conformally covering the dielectric layer.

### CROSS REFERENCE TO RELATED APPLICATIONS

This patent application is a National Stage Entry of PCT/CN2018/084338 filed on Apr. 25, 2018, which claims the benefit and priority of Chinese Patent Application No. 201710569209.3 filed on Jul. 13, 2017, the disclosures of which are incorporated by reference herein in their entirety as part of the present application.

### BACKGROUND

Embodiments of the present disclosure relate to the field of display technologies, and in particular, to an array substrate and a method for manufacturing the same, a display panel and a method for manufacturing the same.

With the mobile phones' functions becoming more powerful and the rapid development of smart wearable products, peoples' requirements on outdoor readability of the displays become higher. In recent years, the reflective liquid crystal displays have been widely used and developed. In addition, the application of electronic tags is more and more common. However, traditional electronic ink type electronic tags can only display black and white or a few colors. In contrast, a total reflection liquid crystal display has advantages of low power consumption, more displayable colors, high resolution, etc. and thus has been widely used.

### BRIEF DESCRIPTION

Embodiments of the present disclosure provide an array substrate and a method for manufacturing the same, a display panel and a method for manufacturing the same.

A first aspect of an embodiment of the present disclosure provides an array substrate. The array substrate includes a substrate, a dielectric layer located on the substrate, the dielectric layer including a matrix material layer and particles embedded into the matrix material layer and the particles forming protrusions on a surface of the dielectric layer opposite to the substrate, and a conductive layer conformally covering the dielectric layer.

In an embodiment of the present disclosure, the particles are spherical particles.

In an embodiment of the present disclosure, the protrusions have a hemispherical shape.

In an embodiment of the present disclosure, the spherical particles have a diameter ranging from about 1.5 μm to about 6 μm.

In an embodiment of the present disclosure, the particles include a silicone resin material or a plastic.

In an embodiment of the present disclosure, the matrix material layer includes a resin material.

A second aspect of an embodiment of the present disclosure provides a display panel. The display panel includes the array substrate described in the first aspect of the embodiment of the present disclosure.

A third aspect of an embodiment of the present disclosure provides a method for manufacturing an array substrate. The method includes forming a dielectric layer on a substrate, the dielectric layer including a matrix material layer and particles embedded into the matrix material layer and wherein the particles forming protrusions on a surface of the dielectric layer opposite to the substrate, and forming a conductive layer on the dielectric layer, the conductive layer conformally covering the dielectric layer.

In an embodiment of the present disclosure, forming the dielectric layer includes mixing the particles with a precursor material for forming the matrix material layer to form a mixture, and applying the mixture to the substrate to form the dielectric layer.

In an embodiment of the present disclosure, the particles are spherical particles.

In an embodiment of the present disclosure, the mass percentage of the particles to the precursor material in the mixture is from about 1 wt % to about 10 wt %.

In an embodiment of the present disclosure, the protrusions have a hemispherical shape.

In an embodiment of the present disclosure, the spherical particles have a diameter ranging from about 1.5 μm to about 6 μm.

In an embodiment of the present disclosure, the particles include a silicone resin material or a plastic.

In an embodiment of the present disclosure, the matrix material layer includes a resin material.

A fourth aspect of an embodiment of the present disclosure provides a method for manufacturing a display panel. The method includes a method for manufacturing an array substrate described in the third aspect of an embodiment of the present disclosure.

Adaptive and further aspects and scope will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present application.

### BRIEF DESCRIPTION OF THE DRAWINGS

The drawings described herein are for illustrative purposes only of selected embodiments and not all possible implementations, and are not intended to limit the scope of the present application.

FIG. 1 is a schematic cross-sectional view schematically showing an array substrate according to an embodiment of the present disclosure;

FIG. 2 is a schematic structural view schematically showing a display panel according to an embodiment of the present disclosure;

FIG. 3 is a schematic cross-sectional view schematically showing a display panel according to an embodiment of the present disclosure;

FIG. 4 is a view schematically showing an optical path in a display panel under a black-state displaying state;

FIG. 5 is a view schematically showing an optical path in a display panel according to an embodiment of the present disclosure under a black-state displaying state; and

FIG. 6 is a flow chart of a method for manufacturing an array substrate according to an embodiment of the present disclosure.

Corresponding reference numerals indicate corresponding parts or features throughout the several views of the drawings.

### DETAILED DESCRIPTION

As used herein and in the appended claims, the singular form of a word includes the plural, and vice versa, unless the context clearly dictates otherwise. Thus, the references “a”, “an”, and “the” are generally inclusive of the plurals of the respective terms. Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. Where used herein the term “examples,” particularly when followed by a listing of terms is merely exemplary and illustrative, and should not be deemed to be exclusive or comprehensive.

In addition, it should be noted that, in the description of the present disclosure, the orientations or positions relationship indicated by the terms “upper”, “above”, “lower”, “under”, “top”, “bottom”, “between”, etc. are the orientations or positions relationship based on the orientations or positions relationship shown in the drawings, which is merely for the convenience of describing the present disclosure and the simplifying the description, and does not indicate or imply that the referred device or element has to have a specific orientation and is constructed and operated in a specific orientation, therefore, it can't be understood as a limitation to the disclosure. In addition, when an element or a layer is referred to as being “on” another element or layer, the element or the layer can be directly on the another element or layer, or an intermediate element or layer can be present; likewise, when an element or a layer is referred to as being “under” another element or layer, the element or the layer can be directly under another element or layer, or at least one intermediate element or layer can be present; when an element or a layer is referred to as being between two elements or two layers, the element or the layer can be an unique element or layer between the two elements or the two layers, or more than one intermediate element or layer can be present.

The flow diagrams depicted herein are just one example. There may be many variations to this diagram or the steps described therein without departing from the spirit of the disclosure. For instance, the steps may be performed in a differing order or steps may be added, deleted, or modified. All of these variations are considered a part of the claimed disclosure.

Example embodiments will now be described more fully with reference to the accompanying drawings.

Reflective liquid crystal display panels have been widely used and developed. However, there is still a need to further improve the reflectivity of the reflective liquid crystal display panels and to enlarge the viewing angle of the display panels.

In an embodiment of the present disclosure, an array substrate and a display panel including the array substrate are provided. The array substrate includes a dielectric layer having protrusions. The protrusions are caused by particles embedded into the dielectric layer, such that a reflective electrode conformally covering the dielectric layer has protrusions having a larger curvature and a higher height. Therefore, the reflectivity of the reflective electrode to an incident light can be increased, thereby enlarging the viewing angle of the display panel.

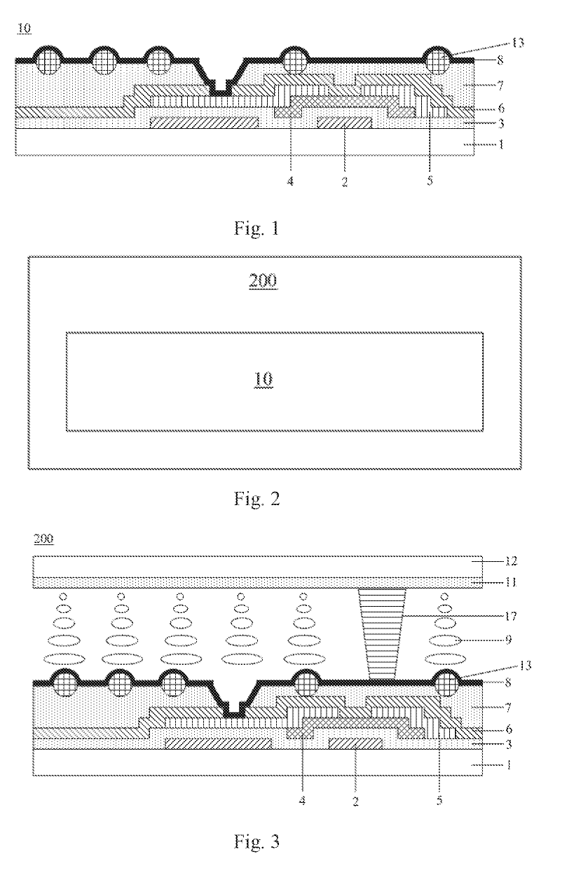

FIG. 1 is a schematic cross-sectional view schematically showing an array substrate according to an embodiment of the present disclosure. As shown in FIG. 1, the array substrate 10 includes a substrate 1, a thin film transistor located on the substrate 1, wherein the thin film transistor includes a gate electrode 2, a gate insulating layer 3, an active layer 4, and a source/drain electrode layer 5, a passivation layer 6 covering the substrate 1 and the thin film transistor, a dielectric layer located on the passivation layer 6, wherein the dielectric layer includes a matrix material layer 7, and a conductive layer 8 conformally covering the matrix material layer 7. Further, the dielectric layer in the array substrate 10 includes, in addition to the matrix material layer 7, particles 13 embedded into the matrix material layer 7. The particles 13 form protrusions on the surface of the side of the dielectric layer opposite to the substrate 1. Thus, the reflectivity of the conductive layer 8 (hereinafter also referred to as “the reflective electrode 8”) to incident light is increased, thereby enlarging the viewing angle of the display panel.

In an embodiment of the present disclosure, the surface of the dielectric layer has a regular protrusion shape. In an embodiment of the present disclosure, the particles 13 may be, for example, spherical. As an example, the protrusions have a hemispherical shape, so that the reflectivity of the reflective electrode 8 to the incident light can be maximized. In an embodiment of the present disclosure, according to the requirements of the curvature and height of the protrusions of the reflective electrode 8, and the formation process and the thickness of the matrix material layer 7, the diameter of the spherical particles may be set in a range of about 1.5 μm to about 6 μm, thereby forming a size-controllable protrusion shape on the surface of the dielectric layer.

In an embodiment of the present disclosure, the particles 13 include a silicone resin material or a plastic. As an example, the matrix material layer 7 may include a resin material. It should be noted that the material of the particles and the matrix material layer is not particularly limited, as long as the protrusions can be formed on the surface of the dielectric layer.

In an embodiment of the present disclosure, the reflective electrode 8 includes a metal layer. As an example, the metal layer includes metal Al or Ag.

Embodiments of the present disclosure also provide a display panel including the above-described array substrate.

FIG. 2 is a schematic structural view schematically showing a display panel according to an embodiment of the present disclosure. As shown in FIG. 2, the display panel 200 includes the array substrate 10. FIG. 3 is a schematic cross-sectional view schematically showing a display panel according to an embodiment of the present disclosure. As shown in FIG. 3, the display panel 200 further includes, in addition to the array substrate 10 shown in FIG. 1, a color filter substrate 12 located opposite to the array substrate 10, a transparent electrode layer 11 located on a side facing the array substrate 10 of the color filter substrate 12, and a liquid crystal 9 and a spacer 17 located between the transparent electrode layer 11 and the reflective electrode 8. In an embodiment of the present disclosure, the color filter substrate 12 includes a black matrix (not shown) and RGB blocks (not shown). As an example, the transparent electrode layer 11 may be a transparent electrode such as ITO (Indium Tin Oxide).

In addition, in an embodiment of the present disclosure, in addition to having an enlarged viewing angle, the display panel 200 can prevent light leakage from occurring when displayed under a black-state, thereby improving the contrast of the reflective liquid crystal display panel.

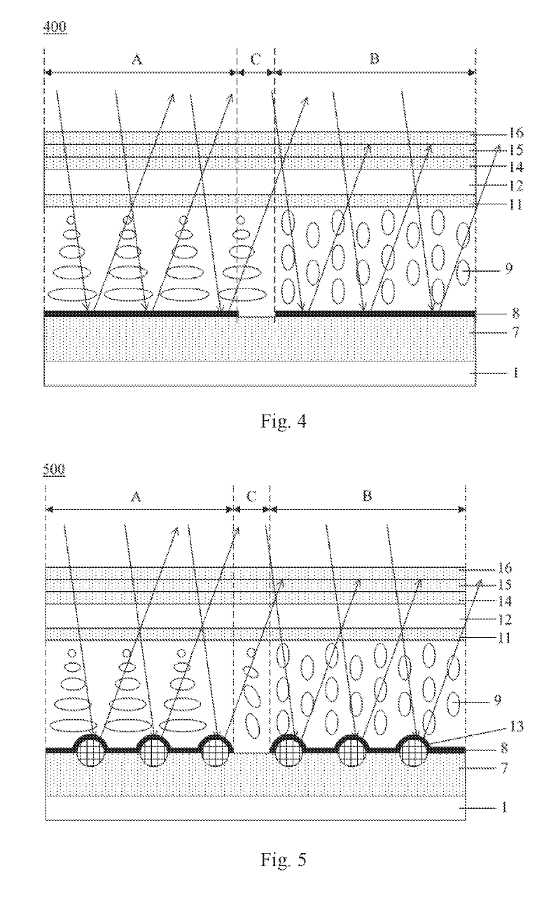

FIG. 4 is a view schematically showing an optical path in a display panel under a black-state displaying state. FIG. 5 is a view schematically showing an optical path in a display panel according to an embodiment of the present disclosure under a black-state displaying state.

As shown in FIGS. 4 and 5, both of the display panels 400 and 500 include the substrate 1, the thin film transistor (not shown), the matrix material layer 7, the reflective electrode 8, the liquid crystal 9, the spacer (not shown), the transparent electrode layer 11, the color filter substrate 12, a quarter wave plate 14, a half wave plate 15, and a polarizer 16. The display panel 500 in FIG. 5 also includes particles 13 (e.g., spherical particles). Regions A in FIGS. 4 and 5 are pixel region A, regions B are pixel region B, and regions C are region C without having a reflective electrode. FIGS. 4 and 5 both have the following arrangement. The pixel region A is not energized, so as to display a white-state, and the pixel region B is energized, so as to display a black-state. The reason why the display panel of the embodiment of the present disclosure can prevent light leakage from occurring when the display panel being energized to display the black-state is explained below.

In FIG. 4, since the surface of the matrix material layer 7 is flat and has no protrusions, when the pixel region A is not energized to display a white-state and the pixel region B is energized to display a black-state, a vertical component of an electric field between a portion of the transparent electrode layer 11 located on the region C without having the reflective electrode and the reflective electrode located on the pixel region B is small, so that the effect on the liquid crystal located within the region C without having the reflective electrode is less, thereby the liquid crystal located within the region C without having the reflective electrode cannot be deflected. Thus, a light reflected by the reflective electrode within the pixel region A enters into the pixel region B, which causes the light leakage to occur within the pixel region B, thereby reducing the contrast of the display panel.

In FIG. 5, since the dielectric layer further includes the particles 13 embedded into the matrix material layer 7, the particles 13 form hemispherical protrusions on the surface of the side opposite to the substrate 1 of the dielectric layer. When the pixel region A is not energized to display a white-state and the pixel region B is energized to display a black-state, the vertical component of the electric field between the portion of the transparent electrode layer 11 located on the region C without having the reflective electrode and the reflective electrode located on the pixel region B is more, so that the effect on the liquid crystal located within the region C without having the reflective electrode is large, thereby the liquid crystal located within the region C without having the reflective electrode can be deflected, and the degree of deflection of the liquid crystal is close to that within the pixel region B. Thus, the light reflected by the reflective electrode within the pixel region A do not enter into the pixel region B, and the light leakage can be effectively prevented from occurring within the pixel region B, thereby improving the contrast of the display panel.

It should be noted that, in order to facilitate to explain the reason why the display panel of the embodiment of the present disclosure can prevent light leakage from occurring, a special example is given as following. That is, for the two adjacent pixels, one pixel is not energized to display the white-state, and the other pixel is energized to display the black-state. However, the embodiment of the present disclosure can effectively prevent light leakage from occurring even when the applied voltages of two adjacent pixels are different, that is, light leakage can be prevented from being occurring within the pixel region applied a larger voltage (that is, performing the black-state displaying).

Embodiments of the present disclosure also provide a method for manufacturing an array substrate. The array substrate manufactured by the method includes a dielectric layer having protrusions, so that a reflective electrode conformally covering the dielectric layer has protrusions with a larger curvature and a higher height, which can increase the reflectivity of the reflective electrode to an incident light, thereby enlarging the viewing angle of the display panel.

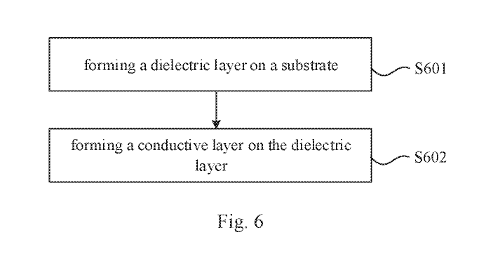

FIG. 6 is a flow chart of a method for manufacturing an array substrate in accordance with an embodiment of the present disclosure. The cross-sectional structure of the array substrate manufactured by this method is as shown in FIG. 1. As shown in FIG. 6, the method includes steps S601 and S602. In step S601, a dielectric layer is formed on a substrate 1. The dielectric layer includes a matrix material layer 7 and particles 13 (for example, spherical particles) embedded into the matrix material layer 7. The particles 13 form protrusions on a surface of the dielectric layer opposite to the substrate 1.

In an embodiment of the present disclosure, the surface of the dielectric layer has a regular protrusion shape. As an example, the protrusions are in a hemisphere shape. In an embodiment of the present disclosure, the material of the particles and the matrix material layer is not particularly limited, as long as the protrusions can be formed on the surface of the dielectric layer and the particles do not affect the film formation property of the matrix material layer.

In an embodiment of the present disclosure, forming the dielectric layer includes mixing the particles 13 with a precursor material for forming the matrix material layer 7 to form a mixture, and applying the mixture to the substrate 1 to form the dielectric layer.

In an embodiment of the present disclosure, the mass percentage of the particles 13 to the precursor material (i.e., the resin material) is from about 1 wt % to about 10 wt %.

As an example, in a case that the mass percentage of the particles (for example, silicon balls) to the resin material is 4.0 wt %, the silicon balls having a diameter of 4.0 μm is uniformly mixed with the resin material to form a mixture. Then, the mixture is coated on the substrate to form a dielectric layer having a thickness of 2.0 μm. It should be noted that the thickness of the dielectric layer herein refers to the thickness of the matrix material layer. As another example, in a case that the mass percentage of the silicon balls to the resin material is 5.0 wt %, the silicon balls having a diameter of 3.0 μm is uniformly mixed with the resin material to form a mixture. Then, the mixture is coated on the substrate to form a dielectric layer having a thickness of 1.5 μm.

As shown in FIG. 6, in step S602, a reflective electrode 8 is formed on the dielectric layer. The reflective electrode 8 conformally covers the dielectric layer. Forming the reflective electrode 8 on the dielectric layer includes sputtering a metal such as Al or Ag on the dielectric layer.

In an embodiment of the present disclosure, before step S601, the method further includes forming a thin film transistor on the substrate 1 and forming a passivation layer 6 on the substrate 1 and the thin film transistor. The thin film transistor includes a gate 2, a gate insulating layer 3, an active layer 4, and a source/drain electrode layer 5.

Embodiments of the present disclosure also provide a method for manufacturing a display panel. The method includes the above method for manufacturing the array substrate. The manufactured display panel has an enlarged viewing angle.

In an embodiment of the present disclosure, the display panel manufactured by the method for manufacturing a display panel is as shown by the display panel 200 of FIG. 3. The method includes, in addition to the above method for manufacturing the array substrate, forming a transparent electrode layer 11 on a color filter substrate 12, wherein the color filter substrate 12 includes a black matrix (not shown) and RGB blocks (not shown), uniformly applying a sealant to the color filter substrate 12 on which the transparent electrode layer 11 is formed, dropping a liquid crystal 9 onto the array substrate 10, and joining the color filter substrate 12 to the array substrate 10, and then carrying out UV polymerization and thermal polymerization. Thereby, a reflective liquid crystal display panel having high reflectivity and a wide viewing angle is formed.

In an embodiment of the present disclosure, the sealant may be, for example, a sealant of the type SWB-73 or SWB-66 which is commercially available from the Sekisui. The liquid crystal is, for example, a liquid crystal of type ZBE-5311 commercially available from JNC or a liquid crystal of type MAT-10-875 commercially available from Merck.

In an embodiment of the present disclosure, the surface of the dielectric layer in the reflective liquid crystal display panel has the protrusions such that the reflective electrode has protrusions having a larger curvature and a higher height, thereby increasing the reflectivity of the reflective electrode to the ambient light. Thus, the viewing angle of the display panel is enlarged. In addition, due to the above-mentioned protrusions, it is possible to effectively prevent light leakage from occurring when the display panel displays under the black-state, thereby improving the contrast of the display panel.

The foregoing description of the embodiments has been provided for purpose of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are included within the scope of the disclosure.

1. An array substrate comprising:
a substrate;
a dielectric layer located on the substrate, the dielectric layer comprising a matrix material layer and particles embedded into the matrix material layer, the particles forming protrusions on a surface of the dielectric layer opposite to the substrate; and
a conductive layer conformally covering the dielectric layer.

2. The array substrate according to claim 1, wherein the particles are spherical particles.

3. The array substrate according to claim 2, wherein the protrusions have a hemispherical shape.

4. The array substrate according to claim 2, wherein the spherical particles have a diameter ranging from about 1.5 μm to about 6 μm.

5. The array substrate according to claim 1, wherein the particles comprise one of a silicone resin material and a plastic.

6. The array substrate according to claim 1, wherein the matrix material layer comprises a resin material.

7. A display panel comprising the array substrate according to claim 1.

8. A method for manufacturing an array substrate, the method comprising:
forming a dielectric layer on a substrate, the dielectric layer comprising a matrix material layer and particles embedded into the matrix material layer, the particles forming protrusions on a surface of the dielectric layer opposite to the substrate; and
forming a conductive layer on the dielectric layer, the conductive layer conformally covering the dielectric layer.

9. The method according to claim 8, wherein forming the dielectric layer comprises mixing the particles with a precursor material for forming the matrix material layer to form a mixture, and applying the mixture to the substrate to form the dielectric layer.

10. The method according to claim 8, wherein the particles are spherical particles.

11. The method according to claim 8, wherein the mass percentage of the particles to the precursor material in the mixture is from about 1 wt % to about 10 wt %.

12. The method according to claim 10, wherein the protrusions have a hemispherical shape.

13. The method according to claim 10, wherein the spherical particles have a diameter ranging from about 1.5 μm to about 6 μm.

14. The method according to claim 8, wherein the particles comprise one of a silicone resin material and a plastic.

15. A method for manufacturing a display panel, wherein the method comprises the method for manufacturing an array substrate according to claim 8.

16. A display panel comprising the array substrate according to claim 2.

17. A display panel comprising the array substrate according to claim 3.

18. A display panel comprising the array substrate according to claim 4.

19. A display panel comprising the array substrate according to claim 5.

20. A display panel comprising the array substrate according to claim 6.
